(19) United States
(12) Patent Application Publication
(10) Pub. No.: US 2013/0262058 A1
(43) Pub. Date: Oct. 3, 2013

(54) MODEL LEARNING APPARATUS, MODEL MANUFACTURING METHOD, AND COMPUTER PROGRAM PRODUCT

(71) Applicant: KABUSHIKI KAISHA TOSHIBA, Tokyo (JP)

(72) Inventor: Yusuke Shinohara, Kanagawa (JP)

(73) Assignee: Kabushiki Kaisha Toshiba, Tokyo (JP)

(21) Appl. No.: 13/852,198

(22) Filed: Mar. 28, 2013

(30) Foreign Application Priority Data
Mar. 29, 2012 (JP) 2012-078036

(51) Int. Cl. G06N 99/00

(52) U.S. Cl. CPC G06N 99/005
USPC 703/2

(57) ABSTRACT

According to an embodiment, a model learning apparatus includes a conversion unit, an allocation unit, an update unit, and a projection unit. The conversion unit is configured to convert each N covariance matrix to obtain N logarithmic covariance vectors. The allocation unit is configured to allocate each N logarithmic covariance vector to a rotation matrix closest to the N logarithmic covariance vector among K rotation matrices obtained from the N covariance matrices. The update unit is configured to specify the logarithmic covariance vector allocated to the allocated K′ rotation matrix and update the allocated K′ rotation matrix on the basis of the specified logarithmic covariance vector. The projection unit is configured to project the N logarithmic covariance vector to a rotation matrix closest to the N logarithmic covariance vector among the updated K′ rotation matrices and K-K′ rotation matrices that have not been updated.

### CROSS-REFERENCE TO RELATED APPLICATION

This application is based upon and claims the benefit of priority from Japanese Patent Application No. 2012-078036, filed on Mar. 29, 2012; the entire contents of which are incorporated herein by reference.

### FIELD

Embodiments described herein relate generally to a model learning apparatus, a model manufacturing method, and a computer program product.

### BACKGROUND

A Gaussian distribution which is used for, for, example, an acoustic model of speech recognition includes a mean vector and a covariance matrix. When the covariance matrix is used to evaluate likelihood without any change, that is, in the form of full covariance matrices, the amount of calculation increases significantly. Therefore, there is a method using diagonal covariance matrices. However, in the diagonal covariance matrix, it is difficult to represent the correlation between variables, which may cause a reduction in the accuracy of speech recognition.

As another method for reducing the amount of calculation for likelihood evaluation, there is a method using semi-tied covariance matrices. In the semi-tied covariance matrix, of a diagonal matrix (a matrix having an eigenvalue as a diagonal element) and a rotation matrix (a matrix including eigenvectors), the rotation matrix obtained by performing eigenvalue decomposition on the covariance matrix is shared. That is, when the semi-tied covariance matrix is used, each Gaussian distribution forming the acoustic model includes a mean vector, a diagonal matrix, and the class of a rotation matrix. A representative rotation matrix of each class of the rotation matrix is stored. Therefore, each Gaussian distribution refers to the rotation matrix corresponding to its class of the rotation matrix. In this way, it is possible to achieve speech recognition capable of preventing a reduction in the accuracy of speech recognition while reducing the amount of calculation for likelihood evaluation.

Here, in the method using the semi-tied covariance matrices, as a method of determining the class to which the Gaussian distribution is to be allocated, a method has been known which determines the class of the Gaussian distribution on the basis of the central phoneme of a triphone to which the Gaussian distribution belongs. In this method, a triphone having each phoneme as the central phoneme is specified, one class is formed by all Gaussian distributions included in the specified triphone, and a representative rotation matrix of the class is shared.

However, the above-mentioned method is not optimal in reproducing the covariance matrix. Therefore, in a model using the covariance matrix after reproduction, there is a concern that the recognition performance will deteriorate, as compared to a model using the covariance matrix before reproduction.

### BRIEF DESCRIPTION OF THE DRAWINGS

FIG. 1 is a diagram illustrating an example of the structure of a model learning apparatus according to a first embodiment;

FIG. 2 is a diagram illustrating an example of a covariance matrix according to the first embodiment;

FIG. 3 is a diagram illustrating an example of logarithmic covariance vectors according to the first embodiment;

FIG. 4 is a diagram illustrating an example of the relation between a space and a subspace of the logarithmic covariance vectors;

FIG. 5 is a diagram illustrating an example of the subspace;

FIG. 6 is a diagram illustrating an example of the subspace;

FIG. 7 is a diagram illustrating an example of the allocation result of an allocation unit according to the first embodiment;

FIG. 8 is a diagram illustrating an example of an aspect in which the scaling of each axis of the covariance matrix is adjusted by projection by a projection unit according to the first embodiment;

FIG. 9 is a diagram illustrating an example of the projection of the projection unit according to the first embodiment in a space of the logarithmic covariance vectors;

FIG. 10 is a diagram illustrating an example of the projection result of the projection unit according to the first embodiment in a space of feature vectors;

FIG. 11 is a flowchart illustrating an example of the process of the model learning apparatus according to the first embodiment;

FIG. 12 is a diagram illustrating a comparative example of a class allocation in a covariance matrix;

FIG. 13 is a diagram illustrating a comparative example of a class allocation in another covariance matrix;

FIG. 14 is a diagram illustrating a comparative example of a class allocation in still another covariance matrix;

FIG. 15 is a diagram illustrating a comparative example of a class allocation in a space of a logarithmic covariance vector;

FIG. 16 is a diagram illustrating an example of the structure of a model learning apparatus according to a second embodiment; and

FIG. 17 is a flowchart illustrating an example of the process of the model learning apparatus according to the second embodiment.

### DETAILED DESCRIPTION

According to an embodiment, a model learning apparatus includes a conversion unit, an allocation unit, an update unit, and a projection unit. The conversion unit is configured to convert each of input N covariance matrices to obtain N logarithmic covariance vectors, where N is equal to or greater than 1. The allocation unit is configured to allocate each of the N logarithmic covariance vectors to a rotation matrix closest to the each of the N logarithmic covariance vectors among K rotation matrices obtained from the N covariance matrices, thereby obtaining allocated K′ rotation matrices, where K is from 1 to N and K′ is from 1 to K. The update unit is configured to specify each of the logarithmic covariance vectors allocated to each of the allocated K′ rotation matrices and update the each of the allocated K′ rotation matrices on the basis of the each of the specified logarithmic covariance vectors. The projection unit is configured to project each of the N logarithmic covariance vectors to a rotation matrix closest to the each of the N logarithmic covariance vectors among the updated K′ rotation matrices and K-K′ rotation matrices that have not been updated.

Hereinafter, embodiments will be described in detail with reference to the accompanying drawings.

### First Embodiment

In a first embodiment, an example in which a covariance matrix included in a Gaussian distribution which is used in a model used for various kinds of recognition, such as speech recognition and character recognition, is learned will be described.

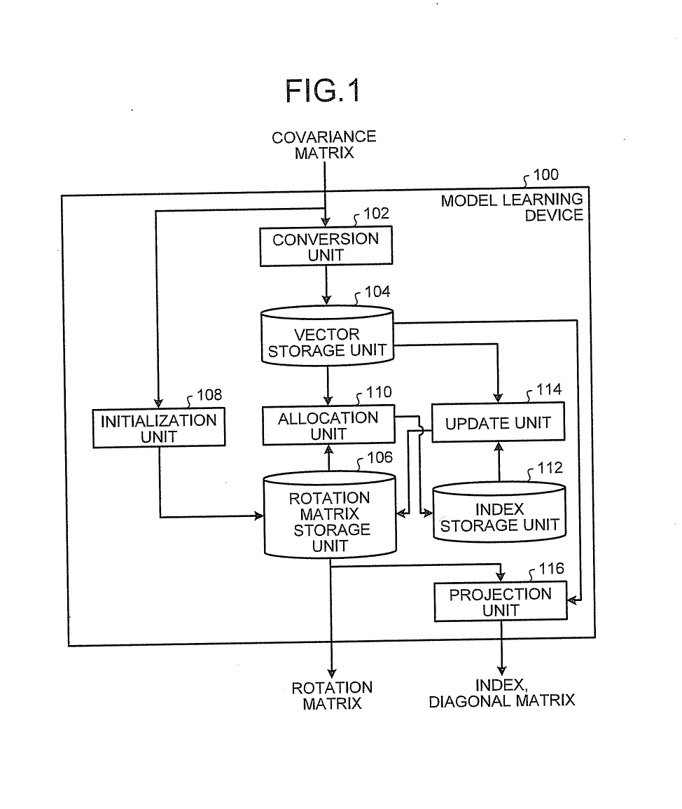

FIG. 1 is a diagram illustrating an example of the structure of a model learning apparatus 100 according to the first embodiment. As illustrated in FIG. 1, the model learning apparatus 100 includes a conversion unit 102, a vector storage unit 104, a rotation matrix storage unit 106, an initialization unit 108, an allocation unit 110, an index storage unit 112, an update unit 114, and a projection unit 116.

The conversion unit 102, the initialization unit 108, the allocation unit 110, the update unit 114, and the projection unit 116 may be implemented by, for example, the execution of a program by a processing device, such as a central processing unit (CPU), that is, software. The vector storage unit 104, the rotation matrix storage unit 106, and the index storage unit 112 may be implemented by at least one of magnetic, optical, and electrical storage devices, such as a hard disk drive (HDD), a solid state drive (SSD), a random access memory (RAM), and a memory card.

N (N≧1) covariance matrices Σ (specifically, covariance matrices {Σ₁, . . . , Σ_{N}}) are input from the outside of the model learning apparatus 100 to the conversion unit 102. It is assumed that the covariance matrix Σ has n (n≧2) rows and n columns. The conversion unit 102 converts each of the input N covariance matrices Σ into logarithmic covariance vectors ξ (specifically, logarithmic covariance vectors {ξ₁, . . . , ξ_{N}}). Specifically, the conversion unit 102 converts each of the input N covariance matrices Σ into logarithmic covariance matrices S (specifically, logarithmic covariance matrices {S₁, . . . , S_{N}}) and converts the converted logarithmic covariance matrices into n(n+1)/2-dimensional logarithmic covariance vectors ξ (specifically, logarithmic covariance vectors {ξ₁, . . . , ξ_{N}}).

Specifically, first, the conversion unit 102 converts the covariance matrix Σ into the logarithmic covariance matrix S (=log(Σ)) using a logarithmic function. For example, assuming that the conversion unit 102 eigen-decomposes the covariance matrix Σ into a rotation matrix U including eigenvectors and a diagonal matrix D including eigenvalues as represented by the following Equation (1), the logarithmic covariance matrix S is calculated by the series expansion of the logarithmic function, as represented by the following Equation (2).

$$\begin{matrix}Σ = {UDU}^{T} & ( 1 ) \\ S = log ( Σ ) = {\sum }_{k = 1}^{∞} \frac{{( - 1 )}^{k - 1}}{k} {( Σ - I )}^{k} = U log ( D ) {U}^{T} & ( 2 )\end{matrix}$$

In Equations (1) and (2), T indicates transposition. In addition, when the eigenvalues of the covariance matrix Σ are λ₁, . . . , λₙ, log(D) is represented by the following Equation (3).

$$log ( D ) = ( \begin{matrix}log {λ}_{1} & 0 & … & 0 \\ 0 & log {λ}_{2} & … & 0 \\ ⋮ & ⋮ & ⋱ & ⋮ \\ 0 & 0 & … & log {λ}_{n}\end{matrix} ) \qquad ( 3 )$$

Then, the conversion unit 102 converts the logarithmic covariance matrix S into a logarithmic covariance vector ξusing matrix vector conversion, as represented by the following Equation (4).

ξ=vec(S) (4)

Here, a matrix vector conversion function vec( ) converts an n×n matrix into an n(n+1)/2-dimensional vector. For example, the matrix vector conversion function vec( ) converts an n×n matrix X in which an element in a p-th (p=1, . . . , n) row and a q-th (q=1, . . . , n) column is x_{pq}, as represented by the following Equation (5):

vec(X)=(x₁₁, . . . ,xₙₙ,\sqrt{2x₁₂}, . . . ,\sqrt{2x₁ₙ},\sqrt{2x₂₃}, . . . ,\sqrt{2x₂ₙ}, . . . ,\sqrt{2x₍ₙ₋₁₎ₙ})^{T} (5)

The conversion unit 102 converts each of the N covariance matrices Σ into the logarithmic covariance vectors in the above-mentioned manner and stores the logarithmic covariance vectors ξ in the vector storage unit 104.

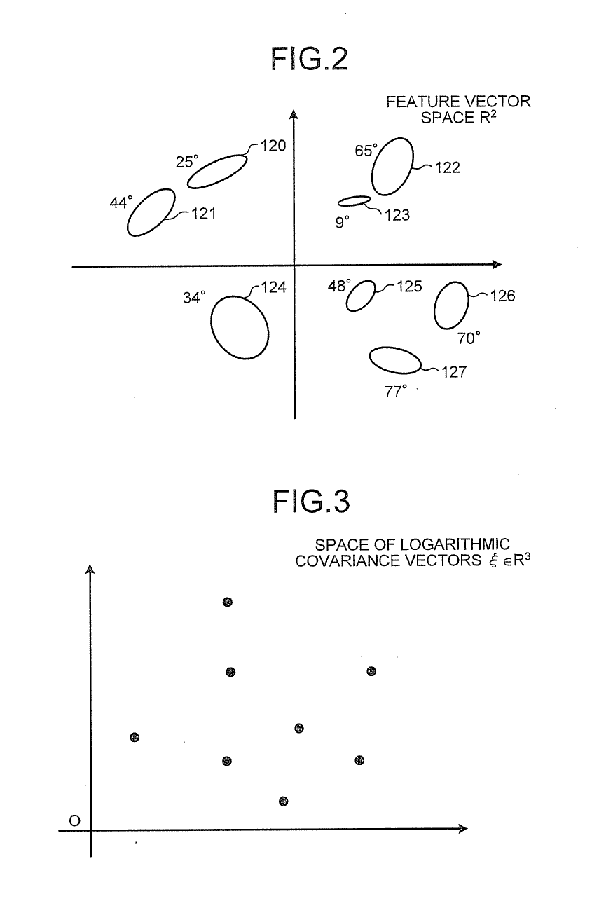

FIG. 2 is a diagram illustrating an example of the N covariance matrices Σ input to the conversion unit 102 according to the first embodiment. In the example illustrated in FIG. 2, N is 8 and covariance matrices 120 to 127 each have a distinct rotation matrix. In the example illustrated in FIG. 2, each of the covariance matrices 120 to 127 is a 2×2 matrix and is represented in a 2-dimensional (n=2) feature vector space.

FIG. 3 is a diagram illustrating an example of the N logarithmic covariance vectors ξ converted by the conversion unit 102 according to the first embodiment. In the example illustrated in FIG. 3, N (N=8) logarithmic covariance vectors ξ converted from the covariance matrices 120 to 127 illustrated in FIG. 2 by the conversion unit 102 are plotted to a space of the logarithmic covariance vectors ξ. When n is 2, the actual space of the logarithmic covariance vectors ξ is three-dimensional (n(n+1)/2-dimensional). However, in FIG. 3, the space of the logarithmic covariance vectors ξ is schematically illustrated as two-dimensional.

Returning to FIG. 1, the vector storage unit 104 stores the N logarithmic covariance vectors ξ (specifically, the logarithmic covariance vectors {ξ₁, . . . , ξ_{N}}) converted by the conversion unit 102.

The rotation matrix storage unit 106 stores K (1≦K≦N) rotation matrices U (specifically, rotation matrices {U₁ . . . , U_{K}}). It is assumed that the rotation matrix U has n rows and n columns. Here, it is assumed that n column vectors of the rotation matrix U are u₁, . . . , uₙ and the rotation matrix U is represented by the following Equation (6). In addition, each of the n column vectors is defined as an n(n+1)/2-dimensional vector, as represented by the following Equation (7).

U=(u₁, . . . ,uₙ) (6)

a_{d}=vec(u_{d}u_{d}^{T}) (7)

In the above-mentioned Equation, vec( ) is the above-mentioned matrix vector conversion function and d is 1, . . . , n.

In this way, it is possible to define n-dimensional subspaces (hereinafter, in some cases, referred to as “subspaces defined by the rotation matrix U”) spanned by a₁, . . . , aₙ in the space of the n(n+1)/2-dimensional logarithmic covariance vectors ξ.

Here, the logarithmic covariance vector ξ has a special property that, in the space of the logarithmic covariance vectors ξ, the covariance matrices Σ have the same rotation matrix, that is, the rotation matrix U, at all points on the subspace defined by the rotation matrix U.

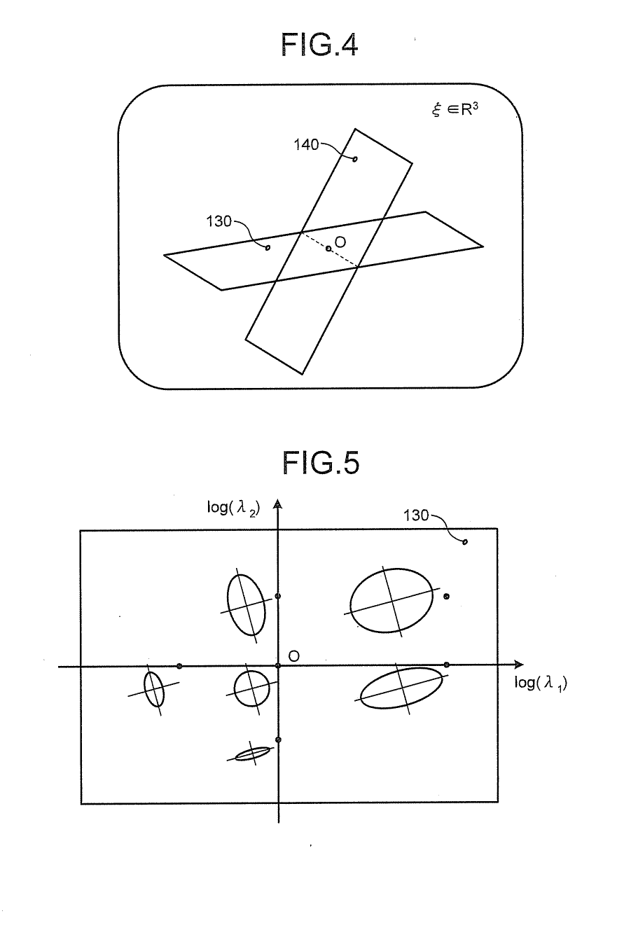

FIG. 4 is a diagram illustrating an example of the relation between the space and the subspace of the logarithmic covariance vectors ξ. As described above, when the feature vector is two-dimensional, the covariance matrix Σ has two rows and two columns and the logarithmic covariance vector ξ is three-dimensional. In this case, the subspace defined by the rotation matrix U is two-dimensional. In the example illustrated in FIG. 4, in the space of the three-dimensional logarithmic covariance vectors ξ, a two-dimensional subspace 130 is defined by the rotation matrix U with a rotation angle θ of 15° and a two-dimensional subspace 140 is defined by the rotation matrix U with a rotation angle θ of 50°. The value of the 2×2 (n=2) rotation matrix U is determined by the rotation angle.

FIG. 5 is a diagram illustrating an example of the subspace 130. In the subspace 130, a first axis (x-axis) indicates the scaling of the first axis direction of the covariance matrix Σ and a second axis (y-axis) indicates the scaling of the second axis direction of the covariance matrix Σ. More specifically, the coordinate, of the first axis is log(λ₁) and the coordinate of the second axis is log(λ₂). λ₁ is an element in the first row and the first column of the diagonal matrix D, that is, the value of the variance of the first axis direction, and λ₂ is an element in the second row and the second column of the diagonal matrix D, that is, the value of the variance of the second axis direction. As described above, the diagonal matrix D and the rotation matrix U are obtained by eigen-decomposition of the covariance matrix Σ.

In the example illustrated in FIG. 5, all of the covariance matrices Σ on the subspace 130 have a rotation angle θ of 15° and all of the covariance matrices Σ on the subspace 130 have the same rotation matrix. In addition, the scaling (variance) of the first axis of the covariance matrix Σ increases toward the right side of the first axis and the scaling (variance) of the first axis of the covariance matrix Σ decreases toward the left side of the first axis. In addition, the scaling (variance) of the second axis of the covariance matrix Σ increases toward the upper side of the second axis and the scaling (variance) of the second axis of the covariance matrix Σ decreases toward the lower side of the second axis.

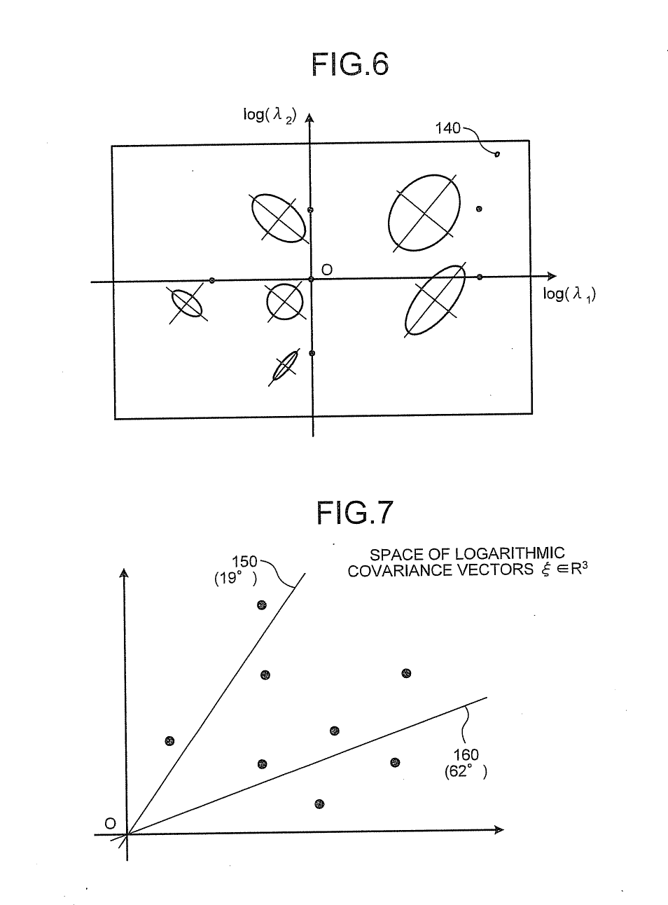

FIG. 6 is a diagram illustrating an example of the subspace 140. The description of the first axis and the second axis and a change in the scaling of the first axis and the second axis are the same as those in FIG. 5 and thus the description thereof will not be repeated. In the example illustrated in FIG. 6, all of the covariance matrices Σ on the subspace 140 have a rotation angle θ of 50° and all of the covariance matrices Σ on the subspace 140 have the same rotation matrix.

In the space of the logarithmic covariance vector ξ the special property of the logarithmic covariance vector ξ that the covariance matrices Σ have the same rotation matrix U at all of the points on the subspace defined by the rotation matrix U is derived from the following Equation (8).

$$log ( Σ ) = U log ( D ) {U}^{T} = {\sum }_{d = 1}^{n} log ( {λ}_{d} ) {u}_{d} {u}_{d}^{T} \qquad ( 8 )$$

That is, the equation states that the logarithmic covariance matrix log(Σ) is represented as a linear combination of u_{d}u_{d}^{T}, where the coefficient of the linear combination is log(λ_{d}), and the special property of the logarithmic covariance vector ξ is derived from the equation.

Returning to FIG. 1, the initialization unit 108 initializes the K rotation matrices U (specifically, rotation matrices {U₁, . . . , U_{K}}) stored in the rotation matrix storage unit 106. In the first embodiment, the initialization unit 108 randomly selects the K rotation matrices U from N rotation matrices U which are obtained by eigen-decomposition of the N covariance matrices Σ input from the outside of the model learning apparatus 100 and stores the selected K rotation matrices U as an initial value in the rotation matrix storage unit 106.

In addition, the initialization unit 108 may select the K rotation matrices U from the N rotation matrices U obtained by the conversion unit 102, or it may eigen-decompose of the N covariance matrices Σ to obtain the N rotation matrices U and select the K rotation matrices U from the obtained N rotation matrices U.

The allocation unit 110 allocates each of the N logarithmic covariance vectors ξ (specifically, the logarithmic covariance vectors {ξ₁, . . . , ξ_{N}}) stored in the vector storage unit 104 to the closest rotation matrix among the K rotation matrices U (specifically, the rotation matrices {U₁, . . . , U_{K}}) stored in the rotation matrix storage unit 106. In this way, among the K rotation matrices U stored in the rotation matrix storage unit 106, K′ (1≦K′≦K) rotation matrices U are allocated. Specifically, the allocation unit 110 generates K subspaces defined by the K rotation matrices U stored in the rotation matrix storage unit 106 and allocates each of the N logarithmic covariance vectors ξ stored in the vector storage unit 104 to the closest subspace. Then, the allocation unit 110 stores the indexes r (specifically, indexes {r₁, . . . r_{N}}) of the subspaces allocated to each of the N logarithmic covariance vectors ξ (specifically, the logarithmic covariance vectors {ξ₁, . . . , ξ_{N}}) in the index storage unit 112 (where r satisfies 1≦r≦K).

FIG. 7 is a diagram illustrating an example of the allocation result of the allocation unit 110 according to the first embodiment. FIG. 7 illustrates the result of the allocation of K (K=2) subspaces to N (N=8) logarithmic covariance vectors ξ in the space of the logarithmic covariance vectors ξ illustrated in FIG. 3. The K subspaces include a two-dimensional subspace 150 with a rotation angle θ of 19° and a two-dimensional subspace 160 with a rotation angle θ of 62°. In practice, the space of the logarithmic covariance vectors ξ is three-dimensional. However, in FIG. 7, the space of the logarithmic covariance vectors ξ is illustrated as two-dimensional. In practice, the subspace is two-dimensional. However, in FIG. 7, the subspace is illustrated as one-dimensional (straight line).

In the first embodiment, the allocation unit 110 measures a Euclidean distance between the subspace and each of the N logarithmic covariance vectors ξ in the space of the logarithmic covariance vectors ξ and allocates each of the logarithmic covariance vectors ξ to the closest subspace. However, the invention is not limited thereto. A known method may be used to measure the Euclidean distance.

For example, when an n-dimensional subspace is spanned by basis vectors v₁, . . . , vₙ and a matrix V is (v₁, . . . , vₙ), a projection matrix P=VV^{T} can be defined and orthogonal projection (foot of a perpendicular) from a vector x to the subspace can be calculated by x_{⊥}=Px. Therefore, the distance (the length of the perpendicular) to the subspace is calculated by |x−Px|. That is, the allocation unit 110 performs orthogonal projection (draw a perpendicular) from each of the N logarithmic covariance vectors ξ to each of the K rotation matrices and specifies the closest rotation matrix.

The validity of measuring the distance between the covariance matrices using the Euclidean distance in the space of the logarithmic covariance vectors is disclosed in, for example, Arsigny, Fillard, Pennec, and Ayache, “Log-Euclidean matrics for fast and simple calculus on diffusion tensors”, Magnetic Resonnance in Medicines, 56: 411-421, 2006.

Returning to FIG. 1, the index storage unit 112 stores N indexes r (specifically, indexes {r₁, . . . , r_{N}}). For example, when an i-th (i=1, . . . , N) logarithmic covariance vector ξᵢ is allocated to the subspace defined by a k-th (k=1, . . . , K) rotation matrix Uₖ, the index storage unit 112 stores k as the value of an i-th index rᵢ.

The update unit 114 specifies the logarithmic covariance vectors ξ allocated to the rotation matrices U in each of the K′ rotation matrices U allocated by the allocation unit 110 and updates the rotation matrices U on the basis of the specified logarithmic covariance vectors ξ (specifically, such that the sum of the square of the orthogonal projection distance from the specified logarithmic covariance vector ξ to the rotation matrix U is reduced). Specifically, the update unit 114 specifies the logarithmic covariance vector ξ allocated to the subspace which is defined by the rotation matrices U in each of the K′ rotation matrices U stored in the rotation matrix storage unit 106 on the basis of the N indexes r (specifically, indexes {r₁, . . . , r_{N}}) stored in the index storage unit 112. Here, in some cases, one logarithmic covariance vector ξ is specified, and in other cases, a plurality of logarithmic covariance vectors are specified. Then, the update unit 114 reads the specified logarithmic covariance vector ξ from the vector storage unit 104 and updates the rotation matrix U such that the sum of the square of the distance from the read logarithmic covariance vector ξ to the subspace is reduced.

Next, a detailed update method will be described using a k-th rotation matrix Uₖ as an example.

First, the update unit 114 specifies the logarithmic covariance vector {ξᵢ|rᵢ=k} allocated to the subspace defined by the rotation matrix Uₖ on the basis of the index r stored in the index storage unit 112 and reads the specified logarithmic covariance vector {ξᵢ|rᵢ=k} from the vector storage unit 104.

Then, the update unit 114 updates the rotation matrix Uₖ such that the sum J(Uₖ) (see Equation (9)) of the square of the distance from the logarithmic covariance vector {ξᵢ|rᵢ=k} to the subspace defined by the rotation matrix Uₖ is reduced.

$$J ( {U}_{k} ) = {\sum }_{i : {r}_{i} = k} {‖ {ξ}_{i} - {ξ}_{i , ⊥} ‖}^{2} \qquad ( 9 )$$

In the above-mentioned Equation, a vector ξ_{i,⊥} indicates a perpendicular foot when a perpendicular is drawn from the logarithmic covariance vector ξᵢ to the subspace defined by the rotation matrix Uₖ.

As a method of updating the rotation matrix U such that the value of an objective function J(U) is reduced, for example, a method disclosed in Edelman, Arias, and Smith, “The geometry of algorithms with orthogonality constraints”, SIAM J. Matrix Anal. Appl., Vol. 20, No. 2, pp. 303-353, 1998. may be used.

Specifically, first, the update unit 114 calculates a differential coefficient F of the objective function J(U), as represented by the following Equation (10).

$$F = \frac{\partial J}{\partial U} \qquad ( 10 )$$

Then, the update unit 114 updates the rotation matrix U to a rotation matrix U′ using the following Equations (11) to (13).

G=F−UF^{T}U (11)

H=U^{T}(−G) (12)

U′=Uexp(ZεH) (13)

In the above-mentioned Equation, exp( ) indicates the exponential function of a matrix. In addition, ε may be a very small positive real number and may be determined to be an appropriate value from the relation with, for example, the amount of calculation or the accuracy of calculation.

The update unit 114 can alternately and repeatedly perform the calculation of the differential coefficient F represented by the Equation 10 and the update of the rotation matrix U represented by Equations 11 to 13 to reduce the value of the target function J(U).

In the model learning apparatus 100 according to the first embodiment, the process of the allocation unit 110 and the process of the update unit 114 are alternately and repeatedly performed to allocate the K subspaces to the N logarithmic covariance vectors. The number of repetitions may be predetermined or the processes may be repeated until predetermined conditions are satisfied.

The projection unit 116 projects (specifically, orthogonally projects) each of the N logarithmic covariance vectors ξ to the closest rotation matrix among the updated K′ rotation matrices U′ and the non-updated K-K′ rotation matrices U. In addition, the projection unit 116 acquires the indexes r of the rotation matrices U to which each of the N logarithmic covariance vectors ξ is to be projected and updates N diagonal matrices D on the basis of the projection (specifically, using the result of orthogonal projection).

Specifically, first, the projection unit 116 performs allocation in the same order as that in which the allocation unit 110 performs allocation. Specifically, the projection unit 116 generates K subspaces which are defined by the updated K′ rotation matrices U′ and the non-updated K-K′ rotation matrices U stored in the rotation matrix storage unit 106. Then, the projection unit 116 allocates each of the N logarithmic covariance vectors ξ (specifically, the logarithmic covariance vectors {ξ₁, . . . , ξ_{N}}) stored in the vector storage unit 104 to the closest subspace and calculates the indexes r (specifically, the indexes {r₁, . . . , r_{N}}) of the allocated subspaces. Then, the projection unit 116 draws a perpendicular from each of the logarithmic covariance vectors ξᵢ to the subspace defined by the rotation matrix U′ᵣᵢ and calculates the foot of the perpendicular ξ_{i,⊥}.

Then, the projection unit 116 calculates a coefficient l_{i,d} (specifically, l_{i,1}, . . . , l_{i,n}) when the calculated foot of the perpendicular ξ_{1,⊥} is represented by the following Equation (14) and calculates a diagonal matrix Dᵢ (see Equation (15)) having the exponentiated value of the calculated coefficient l_{i,d} as a diagonal component.

$$\begin{matrix}{ξ}_{i , ⊥} = {\sum }_{d = 1}^{n} {l}_{i , d} {a}_{d} & ( 14 ) \\ {D}_{i} = ( \begin{matrix}exp {1}_{i , 1} & 0 & … & 0 \\ 0 & exp {1}_{i , 2} & … & 0 \\ ⋮ & ⋮ & ⋱ & ⋮ \\ 0 & 0 & … & exp {1}_{i , n}\end{matrix} ) & ( 15 )\end{matrix}$$

In this way, the diagonal matrix D (the scaling of each axis of the covariance matrix Σ) is appropriately adjusted.

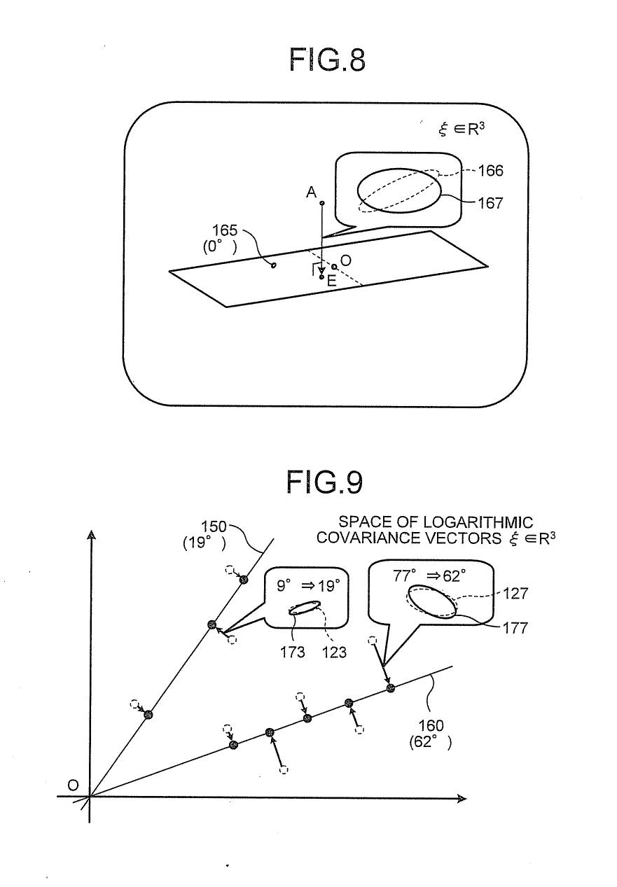

FIG. 8 is a diagram illustrating an example of an aspect in which the scaling of each axis of the covariance matrix Σ is adjusted by the projection by the projection unit 116 according to the first embodiment. In FIG. 8, the projection unit 116 selects a covariance matrix which is closest to a point A indicating a covariance matrix 166, that is, the foot of the perpendicular (point E) from a set of covariance matrices in a subspace 165 with a rotation angle θ of 0°. Therefore, the covariance matrix 166 is changed to a covariance matrix 167 and the scaling of each axis is changed. As such, when the distance between the logarithmic covariance vector ξ and the updated subspace (rotation matrix) is measured, it is possible to allocate the logarithmic covariance vector ξ to an appropriate subspace (rotation matrix).

Then, the projection unit 116 outputs the calculated indexes r (specifically, the indexes {r₁, . . . r_{N}}) and the diagonal matrices D (specifically, the diagonal matrices {D₁, . . . , D_{N}}).

FIG. 9 is a diagram illustrating an example of the projection by the projection unit 116 according to the first embodiment in the space of the logarithmic covariance vectors ξ. In the example illustrated in FIG. 9, the projection unit 116 projects each of N (N=8) logarithmic covariance vectors ξ in the space of the logarithmic covariance vectors ξ illustrated in FIG. 7 to the closest subspace among K (K=2) subspaces. Similarly to FIG. 7, the K subspaces include a two-dimensional subspace 150 with a rotation angle θ of 19° and a two-dimensional subspace 160 with a rotation angle θ of 62°. These subspaces have been updated by the update unit 114. By the projection, for example, the covariance matrix 123 (see FIG. 2) with a rotation angle θ of 9° is replaced with a covariance matrix 173 with a rotation angle θ of 19° and the covariance matrix 127 (see FIG. 2) with a rotation angle θ of 77° is replaced with a covariance matrix 177 with a rotation angle θ of 62°. In addition, as described with reference to FIG. 8, the value of the diagonal matrix D is also changed by the projection.

The model learning apparatus 100 outputs the updated K′ rotation matrices U′ and the non-updated K-K′ rotation matrices U stored in the rotation matrix storage unit 106, and the indexes r (specifically, the indexes {r₁, . . . r_{N}}) and the diagonal matrices D (specifically, the diagonal matrices {D₁, . . . , D_{N}}) output by the projection unit 116.

The rotation matrices, the indexes r, and the diagonal matrices D output by the model learning apparatus 100 are used to approximate an i-th covariance matrix Σᵢ among the N covariance matrices Σ, as represented by the following Equation (16). That is, it is possible to quantize the rotation matrix U obtained by performing eigenvalue decomposition on the covariance matrix Σ.

Σᵢ≈U′ᵣ_{ᵢ}DᵢU′ᵣ_{ᵢ}^{T} (16)

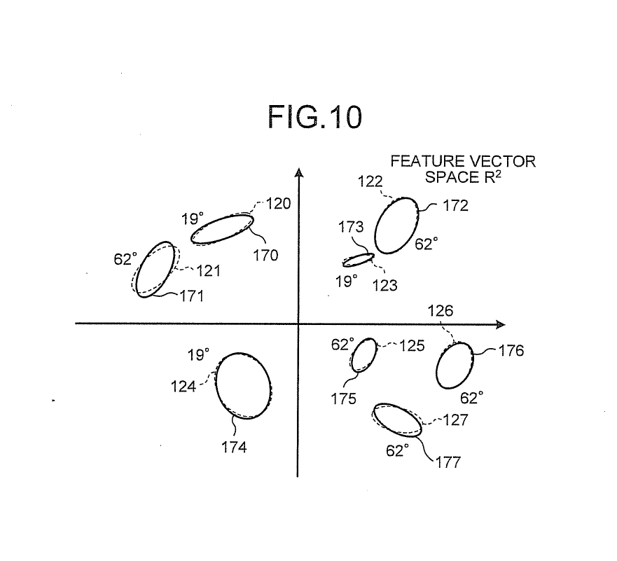

FIG. 10 is a diagram illustrating an example of the projection result obtained by the projection unit 116 according to the first embodiment in the space of feature vectors. That is, FIG. 10 illustrates the result of returning each of the N logarithmic covariance vectors ξ to the covariance matrix Σ using reverse conversion of the above-mentioned conversion. In the example illustrated in FIG. 10, the covariance matrices 120, 123, and 124 (see FIG. 2) are replaced with covariance matrices 170, 173, and 174 with a rotation angle θ of 19° and the covariance matrices 121, 122, 125, 126, and 127 (see FIG. 2) are replaced with covariance matrices 171, 172, 175, 176, and 177 with a rotation angle θ of 62°. That is, the rotation angle θ of the covariance matrices 170 to 177 is 19° or 62°.

As such, in the first embodiment, when the covariance matrices are replaced, the rotation matrices of the covariance matrices are aligned (shared) and the covariance matrices are converted into semi-tied covariance matrices. Therefore, it is possible to evaluate likelihood with a small amount of calculation when the semi-tied covariance matrices are used and calculate the likelihood at a high speed. In addition, since the replaced covariance matrix is approximate to the covariance matrix (the covariance matrix input to the model learning apparatus 100) before replacement, it is possible to calculate a value approximate to the original likelihood with high accuracy.

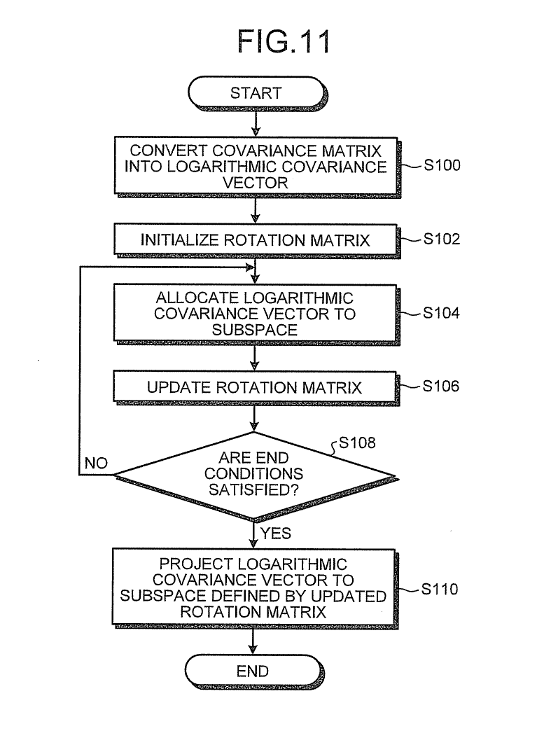

FIG. 11 is a flowchart illustrating an example of the process performed by the model learning apparatus 100 according to the first embodiment.

First, the conversion unit 102 converts each of the input N covariance matrices Σ into the logarithmic covariance vectors ξ and stores the logarithmic covariance vectors ξ in the vector storage unit 104 (Step S100).

Then, the initialization unit 108 randomly selects K rotation matrices U from the N rotation matrices U obtained by performing eigenvalue decomposition on the input N covariance matrices Σ and stores the selected K rotation matrices U as an initial value in the rotation matrix storage unit 106 to initialize the rotation matrices U (Step S102).

Then, the allocation unit 110 generates K subspaces defined by the K rotation matrices U stored in the rotation matrix storage unit 106, allocates each of the N logarithmic covariance vectors ξ stored in the vector storage unit 104 to the closest subspace, and stores the indexes r of the allocated subspaces in the index storage unit 112 (Step S104).

Then, the update unit 114 specifies the logarithmic covariance vector ξ allocated to the subspace which is defined by each of the K′ rotation matrices U stored in the rotation matrix storage unit 106 on the basis of the N indexes r stored in the index storage unit 112 and updates the rotation matrices U such that the sum of the square of the distance from the specified logarithmic covariance vector ξ to the subspace is reduced (Step S106).

The allocation unit 110 and the update unit 114 repeatedly perform the process of Steps S104 and S106 until end conditions, such as the number of repetitions, are satisfied (No in Step S108).

Then, when the end conditions are satisfied (Yes in Step S108), the projection unit 116 generates K subspaces defined by the updated K′ rotation matrices U′ and the non-updated K-K′ rotation matrices U stored in the rotation matrix storage unit 106, projects each of the logarithmic covariance vectors ξ to the closest subspace, calculates the diagonal matrix, and outputs N indexes r and N diagonal matrices D (Step S110).

Finally, the model learning apparatus 100 outputs the updated K′ rotation matrices U′ and the non-updated K-K′ rotation matrices U stored in the rotation matrix storage unit 106 and the indexes r and the diagonal matrices D output by the projection unit 116.

As described above, according to the first embodiment, the K subspaces are allocated to the N logarithmic covariance vectors to obtain (share) K rotation matrices of the N covariance matrices and the covariance matrices are converted into semi-tied covariance matrices. Therefore, it is possible to evaluate likelihood with a small amount of calculation when the semi-tied covariance matrices are used and calculate the likelihood at a high speed.

According to the first embodiment, a class (index) for designating the rotation matrix to be used by each covariance matrix is determined on the basis of the logarithmic covariance vector. Therefore, it is possible to reproduce the original covariance matrix with high accuracy and calculate a value approximate to the likelihood of the original covariance matrix with high accuracy. Therefore, it is possible to improve the recognition performance.

In the first embodiment, when each of the logarithmic covariance vectors is allocated to the subspace, a perpendicular is drawn from the logarithmic covariance vector to the subspace to specify the closest subspace and the logarithmic covariance vector is allocated to the specified subspace. Therefore, according to the first embodiment, since the class of the rotation matrix is selected considering a change in the value of the diagonal matrix (the scaling of each axis) in addition to a change in the value of the rotation matrix, it is possible to select the appropriate class of the rotation matrix. In this way, it is possible to further improve the reproducibility of the original covariance matrix and thus further improve the recognition performance.

Next, the superiority of a class determining method according to the first embodiment will be described in comparison with a method of determining the class to which the Gaussian distribution is to be allocated on the basis of the maximum likelihood criterion disclosed in the document of M. Gales.

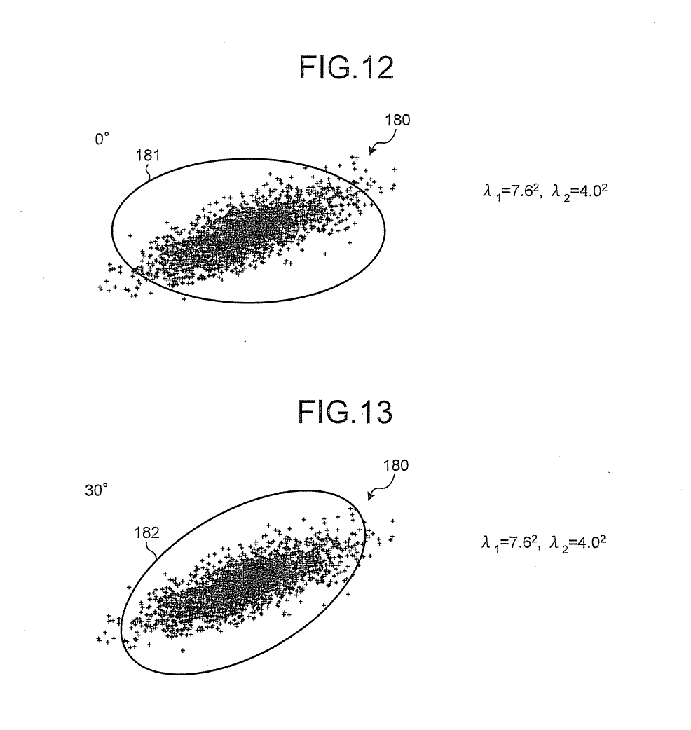

FIGS. 12 to 15 are diagrams illustrating comparative examples of the first embodiment and also diagrams illustrating the problems of the method of determining class allocation on the basis of the maximum likelihood criterion according to the related art.

First, a situation is considered in which the variance (λ₁) of the covariance matrix in the first axis direction is 7.6² (that is, the standard deviation is 7.6), the variance (A₂) of the covariance matrix in the second axis direction is 4.0², there are K (K=2) rotation matrices, the rotation angle θ of one of the rotation matrices is 0°, and the rotation angle θ of the other rotation matrix is 30°. In this case, in the determining method according to the related art which determines class allocation on the basis of the maximum likelihood criterion, a rotation matrix is selected such that the likelihood of a given feature vector set 180 (Gaussian distribution) is increased.

FIG. 12 illustrates a covariance matrix 181 in which the rotation angle θ of the rotation matrix is 0°. In the covariance matrix 181, the variance (λ₁) in the first axis direction is 7.6², the variance (λ₂) in the second axis direction is 4.0², and the rotation angle θ is 0°. FIG. 13 illustrates a covariance matrix 182 in which the rotation angle θ of the rotation matrix is 30°. In the covariance matrix 182, the variance (λ₁) of the first axis direction is 7.6², the variance (λ₂) in the second axis direction is 4.0², and the rotation angle θ is 30°.

When FIG. 12 is compared with FIG. 13, the likelihood of the covariance matrix 181 is higher for that of the feature vector set 180. Therefore, in the determining method according to the related art which determines class allocation on the basis of the maximum likelihood criterion, the feature vector set 180 (Gaussian distribution) is allocated to the class of the rotation matrix with a rotation angle θ of 0°.

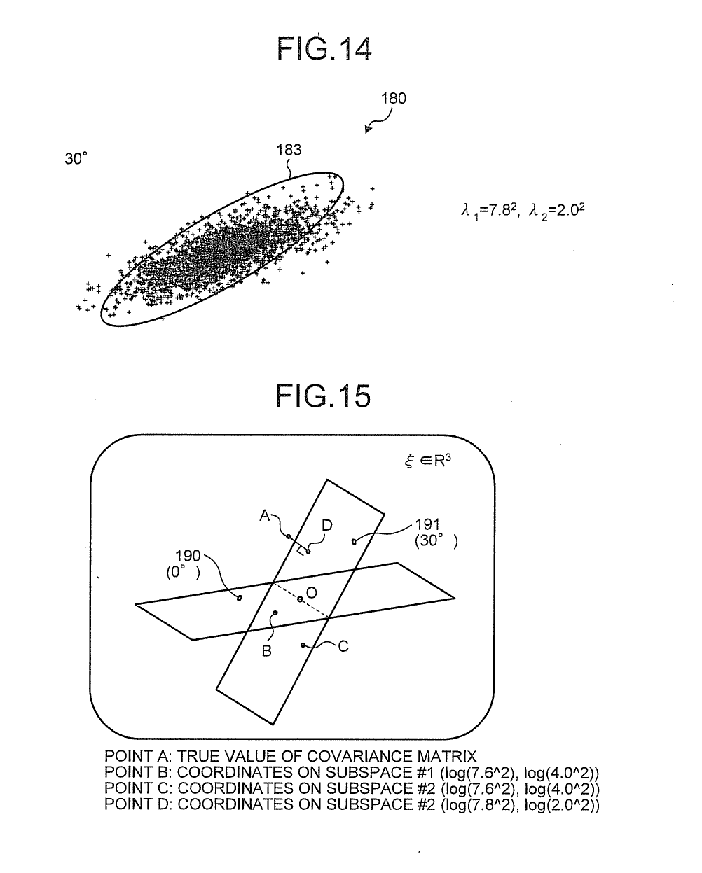

However, as can be seen from FIG. 14, the rotation angle θ of the rotation matrix is 30°, but a covariance matrix 183 (the variance (λ₁) in the first axis direction is 7.8² and the variance (A₂) in the second axis direction is 2.0²) in which the variance of the first axis direction and the variance of the second axis direction are appropriately adjusted is more fit (has a higher likelihood) for than the feature vector set 180.

Therefore, in this situation, it is appropriate to allocate the feature vector set 180 (Gaussian distribution) to the class of the rotation matrix with a rotation angle θ of 30°.

In the determining method according to the related art which determines class allocation on the basis of the maximum likelihood criterion, the rotation matrix is replaced, with the diagonal matrix (the variance of each axis) being fixed, and the rotation matrix with the highest likelihood is selected. Therefore, in the above-mentioned situation, it is difficult to select an appropriate class.

In addition, the problems of the determining method according to the related art which determines class allocation on the basis of the maximum likelihood criterion will be described in the space of the logarithmic covariance vectors illustrated in FIG. 15. In the example illustrated in FIG. 15, in the space of the logarithmic covariance vectors ξ, a subspace 190 (subspace #¹) is defined by the rotation matrix with a rotation angle θ of 0° and a subspace 191 (subspace #2) is defined by the rotation matrix with a rotation angle θ of 30°.

A point A indicates a logarithmic covariance vector obtained by converting the covariance matrix of a given feature vector set 180. In the determining method according to the related art which determines class allocation on the basis of the maximum likelihood criterion, the variance (λ₄) of the covariance matrix in the first axis direction is fixed to 7.6² and the variance (λ₂) of the covariance matrix in the second axis direction is fixed to 4.0², which means that the coordinate values are fixed to (log(7.6²), log(4.0²)) in the subspace.

In the situation in which the coordinate values are fixed, a distance AB, which is a distance from the point A to a point B where the coordinate values in the subspace 190 are (log(7.6²), log(4.0²)), is compared with a distance AC, which is a distance from the point A to a point C where the coordinate values in the subspace 191 are (log(7.6²), log(4.0²)), to allocate the logarithmic covariance vector ξ to the subspace. Here, it may be considered that the distance AB or the distance AC is approximately inversely proportional to likelihood. As illustrated in FIG. 15, since the distance AB<the distance AC is satisfied, the logarithmic covariance vector (point A) is allocated to the subspace 190 in the determining method according to the related art which determines class allocation on the basis of the maximum likelihood criterion.

However, when the coordinate values can be adjusted, there is a point D, which is the foot of a perpendicular from the subspace 191 to the point A, and the distance AB>a distance AD is satisfied, as illustrated in FIG. 15. Therefore, it is appropriate to allocate the logarithmic covariance vector (point A) to the subspace 191.

In the determining method according to the related art which determines class allocation on the basis of the maximum likelihood criterion, the distances are compared with each other, with the coordinate values, which are the diagonal matrix (the variance of each axis), being fixed. Therefore, in the above-mentioned situation, it is difficult to allocate the logarithmic covariance vector ξ to an appropriate subspace and select an appropriate class.

In contrast, in the method according to the first embodiment, when the distance from the logarithmic covariance vector ξ to the subspace is calculated, a perpendicular is drawn from the logarithmic covariance vector ξ to the subspace to calculate the distance. Therefore, according to the first embodiment, the class of the rotation matrix is selected, considering a change in the value of the diagonal matrix (the scaling of each axis) in addition to a change in the value of the rotation matrix. As a result, it is possible to select the appropriate class of the rotation matrix, without causing the above-mentioned problems.

The covariance matrix (model) learned by the model learning apparatus 100 according to the first embodiment can be used as an acoustic model used for speech recognition or a model used for character recognition. As the acoustic model, for example, a hidden Markov model using a Gaussian mixture distribution as the output distribution is used.

### Second Embodiment

In a second embodiment, an example in which the acoustic model is learned will be described. The difference from the first embodiment will be mainly described. In the second embodiment, components having the same functions as those in the first embodiment are denoted by the same names and reference numerals as those in the first embodiment and the description thereof will not be repeated.

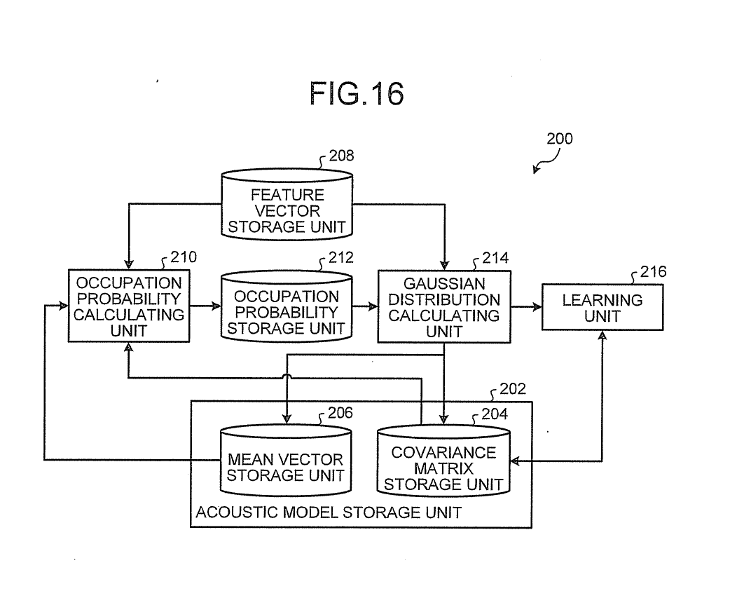

FIG. 16 is a diagram illustrating an example of the structure of a model learning apparatus 200 according to the second embodiment. As illustrated in FIG. 16, the model learning apparatus 200 includes an acoustic model storage unit 202 including a covariance matrix storage unit 204 and a mean vector storage unit 206, a feature vector storage unit 208, an occupation probability calculating unit 210, an occupation probability storage unit 212, a Gaussian distribution calculating unit 214, and a learning unit 216. The learning unit 216 corresponds to the model learning apparatus 100 according to the first embodiment.

The acoustic model storage unit 202 (the covariance matrix storage unit 204 and the mean vector storage unit 206), the feature vector storage unit 208, and the occupation probability storage unit 212 may be implemented by at least one of magnetic, optical, and electrical storage devices, such as an HDD, an SSD, a RAM, and a memory card. The occupation probability calculating unit 210 and the Gaussian distribution calculating unit 214 may be implemented by the execution of a program by a processing device, such as a CPU, that is, software.

The acoustic model storage unit 202 stores an acoustic model represented by the hidden Markov model having a Gaussian mixture distribution as an output distribution. In the second embodiment, it is assumed that the acoustic model is represented by M (M≧1) Gaussian distributions and each of the Gaussian distributions has a mean vector μ and a covariance matrix Σ.

The covariance matrix storage unit 204 stores M covariance matrices Σ (specifically, covariance matrices {Σ₁, . . . , Σ_{M}}) and the mean vector storage unit 206 stores M mean vectors μ (specifically, mean vectors {μ₁, . . . , μ_{M}}).

The feature vector storage unit 208 stores a feature vector o(t) (where t is 1, . . . , T (T≧1)).

The occupation probability calculating unit 210 acquires a t-th feature vector o(t) from the feature vector storage unit 208, acquires an m-th (m=1, . . . , M) Gaussian distribution (a mean vector μₘ and a covariance matrix Σₘ) from the acoustic model storage unit 202, and calculates the occupation probability γₘ(t) of the acquired feature vector o(t) in the acquired Gaussian distribution. Then, the occupation probability calculating unit 210 stores the calculated occupation probability γₘ(t) in the occupation probability storage unit 212. The occupation probability calculating unit 210 calculates the occupation probability γₘ(t) using, for example, a forward backward algorithm.

The forward backward algorithm is a known technique and is disclosed in, for example, Rabiner, “A Tutorial on Hidden Markov Models and Selected Applications in Speech Recognition”, Proceedings of the IEEE, Vol. 77, No. 2, pp. 257-286, February 1989.

The occupation probability storage unit 212 stores the occupation probability γₘ(t).

The Gaussian distribution calculating unit 214 acquires the t-th feature vector o(t) from the feature vector storage unit 208, acquires the occupation probability γₘ(t) from the occupation probability storage unit 212, calculates each Gaussian distribution (a mean vector μ and a covariance matrix Σ), and updates the acoustic model of the acoustic model storage unit 202. The Gaussian distribution calculating unit 214 calculates an m-th mean vector μₘ using, for example, the following Equation (17) and calculates an m-th covariance matrix Σₘ using, for example, the following Equation (18). In addition, when using the Gaussian mixture distribution, the Gaussian distribution calculating unit 214 also updates a mixing coefficient.

$$\begin{matrix}{μ}_{m} = \frac{{\sum }_{t = 1}^{T} {γ}_{m} ( t ) {o}_{t}}{{\sum }_{t = 1}^{T} {γ}_{m} ( t )} & ( 17 ) \\ {\sum }_{m} = \frac{{\sum }_{t = 1}^{T} {γ}_{m} ( t ) ( {o}_{t} - {μ}_{m} ) {( {o}_{t} - {μ}_{m} )}^{T}}{{\sum }_{t = 1}^{T} {γ}_{m} ( t )} & ( 18 )\end{matrix}$$

The Gaussian distribution is calculated by a known technique which is disclosed in, for example, the above-mentioned document of Rabiner.

The learning unit 216 learns the covariance matrix Σ using the method described in the first embodiment. Specifically, the learning unit 216 acquires M covariance matrices Σ from the covariance matrix storage unit 204, learns the M covariance matrices Σ using the method described in the first embodiment, and acquires K rotation matrices U′, M indexes r, and M diagonal matrices D. Then, the learning unit 216 updates the M covariance matrices Σ in the covariance matrix storage unit 204 with the K rotation matrices U′, the M indexes r, and the M diagonal matrices D. The learning unit 216 updates the m-th covariance matrix Σₘ using, for example, the following Equation (19).

Σₘ←U′ᵣ_{ₘ}DₘD′ᵣ_{ₘ}^{T} (19)

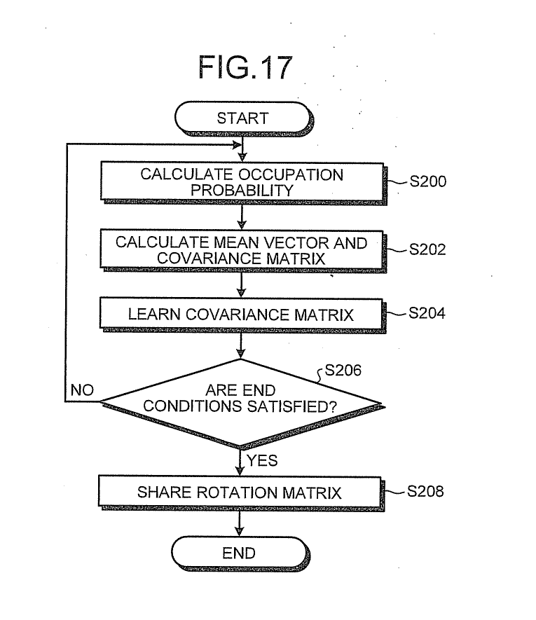

FIG. 17 is a flowchart illustrating an example of the process performed by the model learning apparatus 200 according to the second embodiment.

First, the occupation probability calculating unit 210 calculates the occupation probability γₘ(t) of the feature vector o(t) in each of M Gaussian distributions for each feature vector o(t), using T feature vectors o(t) and the M Gaussian distributions (M mean vectors μ and M covariance matrices Σ) (Step S200).

Then, the Gaussian distribution calculating unit 214 calculates M Gaussian distributions using T feature vectors and T×M occupation probabilities and updates the M mean vector μ and the M covariance matrices Σ (Step S202).

Then, the learning unit 216 learns all of the covariance matrices Σ (Step S204).

The occupation probability calculating unit 210, the Gaussian distribution calculating unit 214, and the learning unit 216 repeatedly perform the process of Steps S200 to S204 until end conditions, such as the number of repetitions, are satisfied (No in Step S206). While the process of Steps S200 to S204 is repeated, the learning unit 216 does not share the rotation matrix. Therefore, the Gaussian distribution calculating unit 214 independently calculates all of the covariance matrices Σ.

Then, when the end conditions are satisfied (Yes in Step S206), the learning unit 216 shares the rotation matrix according to the index (class) of the rotation matrix obtained by learning in the covariance matrix storage unit 204 (Step S208). That is, the learning unit 216 converts the covariance matrix into a semi-tied covariance matrix.

Finally, the model learning apparatus 200 outputs the acoustic model (the covariance matrix and the mean vector) stored in the acoustic model storage unit 202.

As described above, according to the second embodiment, it is possible to evaluate likelihood using the acoustic model with a small amount of calculation and calculate the likelihood at a high speed. In addition, it is possible to improve the speech recognition performance.

Hardware Structure

The model learning apparatus according to each of the above-described embodiments can be implemented by a hardware structure which uses a general computer and includes a control device, such as a CPU, a storage device, such as a read only memory (ROM) or a RAM, an external storage device, such as an HDD or an SSD, a display device, such as a display, an input device, such as a mouse or a keyboard, and a communication I/F.

The program executed by the model learning apparatus according to each of the above-described embodiments is recorded as an installable or executable file on a computer-readable storage medium, such as a CD-ROM, CD-R, a memory card, a digital versatile disk (DVD), or a flexible disk (FD), and is then provided as a computer program product.

In addition, the program executed by the model learning apparatus according to each of the above-described embodiments may be stored in a computer connected to a network, such as the Internet, downloaded through the network, and then provided. Furthermore, the program executed by the model learning apparatus according to each of the above-described embodiments may be provided or distributed through the network, such as the Internet.

The program executed by the model learning apparatus according to each of the above-described embodiments may be incorporated into, for example, a ROM and then provided.

The program executed by the model learning apparatus according to each of the above-described embodiments causes the computer to function as each of the above-mentioned units. As the actual hardware, for example, a control device reads the program from an external storage device onto the storage device and executes the program. In this way, each of the above-mentioned units is implemented on the computer.

As described above, according to each of the above-described embodiments, it is possible to improve the recognition performance while reducing the amount of calculation.

For example, in the flowchart according to each of the above-described embodiments, the order in which steps are performed may be changed, steps may be performed at the same time, or steps may be performed in different orders for each process, without departing from the scope and spirit of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A model learning apparatus comprising:
a conversion unit configured to convert each of input N covariance matrices to obtain N logarithmic covariance vectors, where N is equal to or greater than 1;
an allocation unit configured to allocate each of the N logarithmic covariance vectors to a rotation matrix closest to the each of the N logarithmic covariance vectors among K rotation matrices obtained from the N covariance matrices, thereby obtaining allocated K′ rotation matrices, where K is from 1 to N and K′ is from 1 to K;
an update unit configured to specify each of the logarithmic covariance vectors allocated to each of the allocated K′ rotation matrices and update the each of the allocated K′ rotation matrices on the basis of the each of the specified logarithmic covariance vectors; and
a projection unit configured to project each of the N logarithmic covariance vectors to a rotation matrix closest to the each of the N logarithmic covariance vectors among the updated K′ rotation matrices and K-K′ rotation matrices that have not been updated.

2. The apparatus according to claim 1, wherein the conversion unit converts each of the N covariance matrices to obtain N logarithmic covariance matrices and converts each of the N logarithmic covariance matrices to obtain the N logarithmic covariance vectors.

3. The apparatus according to claim 1, wherein the projection unit acquires indexes of the rotation matrices to which each of the N logarithmic covariance vectors is projected and updates N diagonal matrices obtained from the N covariance matrices on the basis of the projection.

4. The apparatus according to claim 3, wherein
the allocation unit performs orthogonal projection from each of the N logarithmic covariance vectors to the respective K rotation matrices to specify the closest rotation matrix, and
the projection unit orthogonally projects each of the N logarithmic covariance vectors to a rotation matrix closest to the each of the N logarithmic covariance vectors among the K′ rotation matrices and the K-K′ rotation matrices and updates the N diagonal matrices using a result of the orthogonal projection.

5. The apparatus according to claim 4, wherein
the update unit specifies each of the logarithmic covariance vectors allocated to each of the allocated K′ rotation matrices and update the each of the allocated K′ rotation matrices so that a sum of squares of orthogonal projection distances is reduced, the each of the orthogonal projection distances being a distance from each of the specified logarithmic covariance vectors to the corresponding rotation matrix in an orthogonal projection.

6. The apparatus according to claim 1, further comprising:
an occupation probability calculating unit configured to calculate occupation probabilities of T feature vectors in each of N Gaussian distributions by using the T feature vectors, and a mean vector and a covariance matrix that form each of the N Gaussian distributions, where T is equal to or greater than 1; and
a Gaussian distribution calculating unit configured to calculate the N Gaussian distributions by using the T feature vectors and the T×N occupation probabilities and updates the N mean vectors and the N covariance matrices,
wherein the conversion unit converts each of the updated N covariance matrices to obtain the N logarithmic covariance vectors.

7. A model manufacturing method comprising:
converting each of input N covariance matrices to obtain N logarithmic covariance vectors, where N is equal to or greater than 1;
allocating each of the N logarithmic covariance vectors to a rotation matrix closest to the each of the N logarithmic covariance vectors among K rotation matrices obtained from the N covariance matrices, thereby obtaining allocated K′ rotation matrices, where K is from 1 to N and K′ is from 1 to K;
specifying each of the logarithmic covariance vectors allocated to each of the allocated K′ rotation matrices;
updating the each of the allocated K′ rotation matrices on the basis of the each of the specified logarithmic covariance vectors; and
projecting each of the N logarithmic covariance vectors to a rotation matrix closest to the each of the N logarithmic covariance vectors among the updated K′ rotation matrices and K-K′ rotation matrices that have not been updated.

8. A computer program product comprising a computer-readable medium containing a program executed by a computer, the program causing the computer to execute:
converting each of input N covariance matrices to obtain N logarithmic covariance vectors, where N is equal to or greater than 1;
allocating each of the N logarithmic covariance vectors to a rotation matrix closest to the each of the N logarithmic covariance vectors among K rotation matrices obtained from the N covariance matrices, thereby obtaining allocated K′ rotation matrices, where K is from 1 to N and K′ is from 1 to K;
specifying each of the logarithmic covariance vectors allocated to each of the allocated K′ rotation matrices;
updating the each of the allocated K′ rotation matrices on the basis of the each of the specified logarithmic covariance vectors; and
projecting each of the N logarithmic covariance vectors to a rotation matrix closest to the each of the N logarithmic covariance vectors among the updated K′ rotation matrices and K-K′ rotation matrices that have not been updated.
